(19) United States
(12) Patent Application Publication
(10) Pub. No.: US 2012/0253809 A1
(43) Pub. Date: Oct. 4, 2012

(54) Voice Verification System

(75) Inventors: Trevor Thomas, Reading (GB); Nicholas Wise, Reading (GB); David Cowell, Reading (GB)

(73) Assignee: BIOMETRIC SECURITY LTD, Reading (GB)

(21) Appl. No.: 13/430,224

(22) Filed: Mar. 26, 2012

Related U.S. Application Data
(60) Provisional application No. 61/499,646, filed on Jun. 21, 2011.

(30) Foreign Application Priority Data
Apr. 1, 2011 (GB) GB1105586.0

(51) Int. Cl. G10L 17/00

(52) U.S. Cl. 704/246; 704/E15.001

(57) ABSTRACT

A voice verification module 308, for example for an interactive voice response system, is disclosed. The voice verification module 308 is configured to select from a store 310 of verification words one or more verification words responsive to a request for a verification phrase and form a verification phrase including said one or more verification words distributed throughout said verification phrase.

### FIELD

The present invention relates to voice verification systems, and methods and apparatus therefore.

In particular, but not exclusively, embodiments of the present invention relate to user authentication systems comprising a voice verification system.

### BACKGROUND

There has been rapid growth in the use of telecommunications systems for transaction processing rather than the traditional “face-to-face” environment. Such transactions may be related to banking or credit/debit card transactions for telephone or online retailing and are typically via an interactive voice response (IVR) system. Evidently, the account holder or purchaser needs to have their identity authenticated before proceeding with the transaction. Interaction over telecommunications systems between a user and a provider of goods or services is not limited to banking or purchasing transactions but includes other interactions where a user needs to be authenticated by the service provider. The term “transaction” will be used hereinafter in the general sense to mean any exchange of information requiring authentication of the user.

User identity authentication may now utilise speaker voice verification instead of or in addition to verification of a PIN number, password, passphrase or a question about personal information for example. In general terms, speaker voice verification compares a voiceprint corresponding to a registered user of the IVR system with the voice of an end user speaking during a transaction with the IVR system. Generally, the voiceprint is of the registered user speaking a verification phrase such as a PIN number, password, passphrase or answer to a personal question established during initial registration of the user with the IVR system.

However, the IVR system is a computer based system and it is possible that during the voice verification phase there is no human interaction or human listener when the phrase is spoken or question is answered. It is therefore possible that should an end-user making a call to the IVR system play a recording of a registered user speaking the verification phrase to the computer-based system the recording used by the calling end user will be verified as the registered user whose recorded voice has been played to the IVR system. Thus, a fraudulent user may gain access to the IVR system and be verified as a bona fide user even if the IVR system is protected by speaker voice verification.

Aspects and embodiments in accordance with the present invention were devised with the foregoing in mind.

### SUMMARY

Viewed from a first aspect, the present invention provides a voice verification module, for example for an interactive voice response system without limitation thereto, the module being configured to select from a store of verification words one or more verification words responsive to a request for a verification phrase and form a verification phrase including said one or more verification words distributed throughout said verification phrase.

Viewed from a second aspect, the present invention provides a method of operating data processing apparatus, for example for an interactive voice response system without limitation thereto. The method comprises selecting from a store of verification words one or more verification words responsive to a request for a verification phrase; and forming a verification phrase including said one or more verification words distributed throughout said verification phrase.

One or more embodiments in accordance with the first and second aspect of the present invention may automatically produce a voice verification phrase suitable for a voice-based challenge response authentication system in which the phrase upon which the challenge response is based is unpredictable or at least difficult to predict. Thus, attempts to commit fraud by recording a registered user's voice when speaking a passphrase may be frustrated.

The unpredictability may not be solely based on their being a plurality of possible responses, but on the fact that the verification words may be placed in different positions in a verification phrase compared to previous verification phrases for the user.

The verification phrase may be formed with one or more non-verification words included in the verification phrase thereby making the verification phrase similar to a phrase that may be written or spoken. This makes the verification phrase easier for a user to remember and therefore repeat when necessary.

If the verification phrase is formed so as to have a natural language meaning then it is again easier for a human user to remember than a phrase which does not have any meaning. Typically, the verification phrase is formed with the one or more non-verification words positioned to provide such a natural language meaning. Examples of non-verification words may be found in the non-exclusive group including: prepositions; conjunctions; definite article; indefinite article, and parts of speech.

Suitably, the verification word store comprises a strong word set that comprises a very small number of words compared to the possible number of words in the relevant language and which can be formed into a plurality of meaningful phrases.

In order to assist in automatically generating verification phrases the store of verification words is arranged into two or more groups of verification words, each group comprising one or more verification words corresponding to a category of verification word.

In use a verification word may be selected from one or more of the two or more groups to form the verification phrase by placing a selected verification word into a position in the verification phrase designated for a group associated with the selected verification word. In this way, meaningful phrases may be generated by knowing which words are to go where in a verification phrase.

A verification phrase template may be provided, the template comprising two or more positions designated for the two or more groups for populating with selected verification words from respective two or more groups forming the verification phrase. Providing such a template is a suitable mechanism for creating an arrangement in which appropriate word types may be placed in their designated positions within the verification phrase.

In order to increase the unpredictability of the generated verification phrases, a verification phrase template may be selected from a store of a plurality of verification phrase templates, respective verification phrase templates having different distributions of positions for said groups. In this way, there are a number of options and patterns in which verification and non-verification words may be distributed in a verification phrase.

Suitably, one or more verification words are distributed in an irregular and/or unpredictable manner throughout the verification phrase.

Viewed from a third aspect, there is provided an user authentication system comprising a voice verification module such as described above. The IVR system may be configured to:
request a registration verification phrase from said voice verification module responsive to said system receiving a request to register a new user;
receive said registration verification phrase from said voice verification module; and
present said registration verification phrase to said new user.

Thus, an interactive voice response system may automatically generate a verification phrase for presentation to a new user as part of the registration process for the system. Typically, the voice verification module is further configured to pseudo-randomly select the one or more verification words from said store of verification words so that the verification phrase used for registration is unpredictable thereby inhibiting fraudulent activity.

The system may be further configured to:
receive a voice utterance of said registration verification phrase from said user;
recognise said one or more verification words in said utterance; and
record a registration voiceprint of said one of more verification words recognised in said utterance and store each said voiceprint in association with a user identity for said new user and each said verification word.

In recognising which of the words in the utterance are verification words it is possible for the system to record only verification words for a registering user. Thus, the amount of data storage required to store the voiceprint is reduced since only voiceprints for verification words are stored, not all the words in a phrase.

Viewed from a fourth aspect there is provided an user authentication system which comprises a voice verification module configured to:
request a verification phrase from said voice verification module responsive to a registered user initiating a transaction with said system;
present said verification phrase to said registered user;
receive a voice utterance of said verification phrase from said registered user; recognise one or more verification words associated with a user identity corresponding to said registered user in said utterance;
record a voiceprint for each recognised verification word; and
compare said voiceprint with said registered voiceprint; and wherein
said voice verification module is further configured to respond to said request to select from said store of verification words one or more verification words associated with said user identity for forming said verification phrase; and
provide said verification phrase to said system for presentation to said registered user.

In a particular embodiment the user authentication system is a part of an Interactive voice response (IVR) system.

Optionally, the system may be distributed between a terminal device, for example a smartphone, and a service running on a server device. The terminal device may collect user details and initiate voice registration with the server application to receive a registration phrase or verification phrase as appropriate for presentation to the user via the terminal device. The terminal device also records a user speaking a registration or verification phrase as appropriate and forwards it to the server application where voiceprints may be stored or compared depending upon whether registration or verification processes have been initiated.

Thus, an automated system for providing the verification phrase to a user having a form which is unpredictable yet containing verification words uttered by the user when registering is provided. By providing a lack of predictability with respect to the verification phrases fraudulent activity may be inhibited.

Viewed from a fifth aspect there is provided a computer program comprising computer program elements which when loaded and executed in a data processing apparatus cause the data processing apparatus to operate in accordance with the various aspects and embodiments recited above.

### LIST OF FIGURES

One or more embodiments in accordance with the invention will now be described, by way of example only, and with reference to the following drawings, in which:

FIG. 1 is a schematic illustration of a communications network coupled to an interactive voice system;

FIG. 2 is a schematic illustration of an overview of an embodiment in accordance with the present invention;

FIG. 3 is a schematic illustration showing respective elements of the modules illustrated in FIG. 2;

FIG. 4 is a process flow diagram illustrating the operation of an IVR module utilising voice verification to authenticate an end-user;

FIG. 5 is a process flow diagram illustrating the operation of various modules of an IVR system for registration of an end-user;

FIG. 6 is a schematic illustration of stored verification phrase data;

FIG. 7 is a process flow diagram illustrating the operation of a liveness module for generating a registration verification phrase in accordance with an embodiment of the invention;

FIG. 8 is a process flow diagram illustrating the operation of a liveness module for generating a verification phrase in accordance with an embodiment of the invention responsive to an end-user accessing the IVR system;

FIG. 9 is a schematic illustration of a second word set which may be used in another embodiment in accordance with the present invention; and

FIG. 10 is a schematic illustration of another embodiment;

FIG. 11 is a process flow control diagram for the user registration operation of a terminal module in accordance with the another embodiment;

FIG. 12 is a process flow control diagram for the user registration operation of an API module in accordance with the another embodiment;

FIG. 13 is a process flow control diagram for the user verification operation of an API module in accordance with the another embodiment;

FIG. 14 is a process flow control diagram for the user verification operation of a terminal module in accordance with the another embodiment.

### DETAILED DESCRIPTION

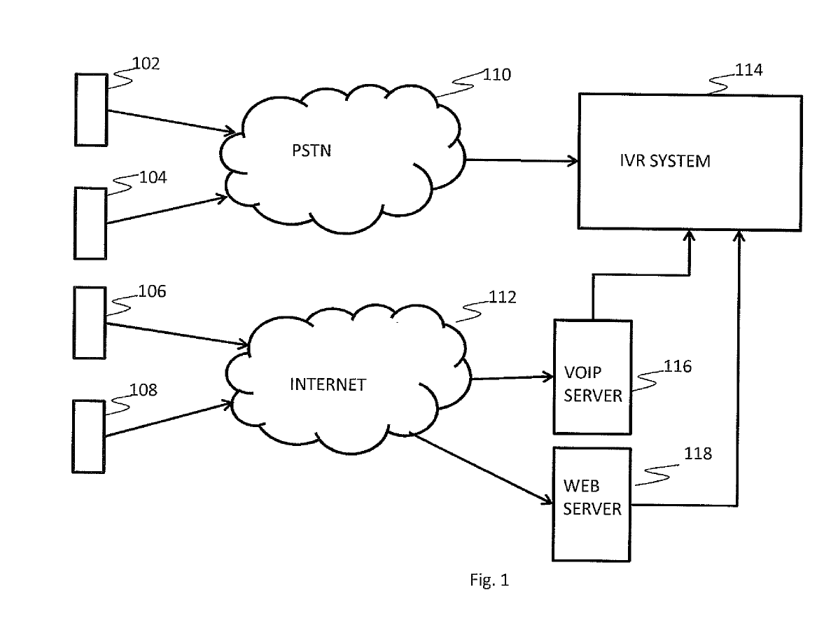

Referring to FIG. 1, a number of voice communication devices are illustrated coupled to respective communication networks. Landline 102 and mobile terminal 104 are connected to the public subscriber telephone network (PSTN) 110, whilst smart phone 106 and laptop or desktop computing device 108 run Voice over Internet Protocol (VoIP) applications and are coupled to the Internet 112 for communicating speech. An IVR system 114 in accordance with one or more embodiments of the present invention is directly coupled to the PSTN 110 and receives telephone calls from users of the IVR system via the PSTN 110. VoIP calls from devices 106 and 108 are directed through the Internet 112 to a VoIP server 116 which couples the voice calls to the IVR system 114. A web server 118 is also coupled to the IVR system 114 and provides a designated webpage through which the IVR system 114 may be accessed from computing devices having audio input and output interfaces. Smart phone 106 and/or mobile computing device 108 may launch a browser application in order to access web server 118 through which interactive voice response system 114 may be accessed.

In operation, the IVR system 114 is used by service providers to authenticate end-users such as customers, subscribers or clients before connecting them to information and/or services provided by the service provider. Typically, the end user makes a telephone calf, often toll-free, or may access a designated website. One or more embodiments in accordance with the present invention need not be limited to the communications networks illustrated in FIG. 1, but may include any communications network capable of communicating speech or voice data.

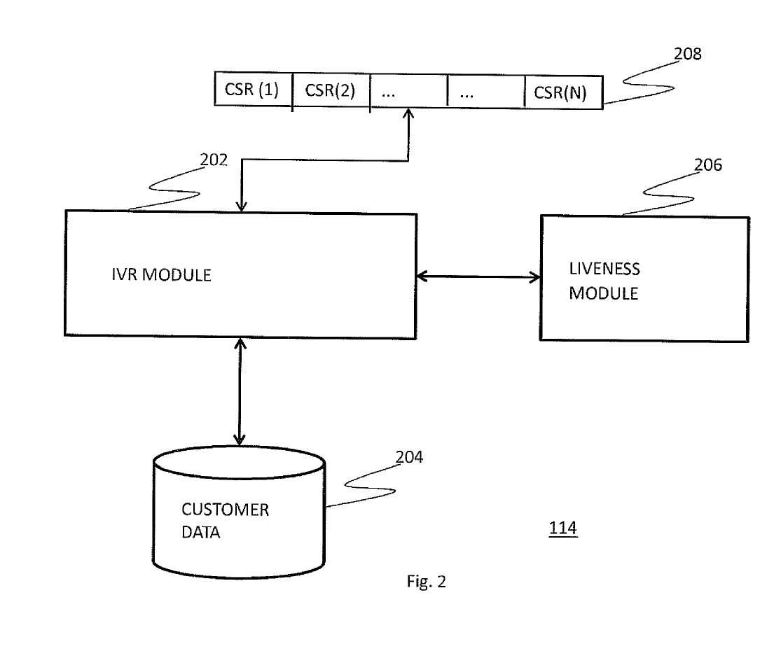

Referring now to FIG. 2, the main modules of the IVR system 114 are schematically illustrated. IVR system 114 comprises an IVR module 202, customer data storage 204 and a “Liveness” verification module 206. The IVR system 114 comprises an IVR module which performs the basic functions of the IVR system including speech recognition for recognising a passphrase input by the end-user and end-user verification services.

The IVR system 114 may also include Customer Service Representatives 208(1), 208(2) . . . 208(N) together 208 which are human operators who may interact with an end-user of the IVR system in certain situations, for example to take an end-user request following verification of an end-user to the IVR system.

Customer data storage 204 is accessed by the IVR module 202 to retrieve relevant customer data corresponding to an end user engaged in a transaction. Additionally, IVR module 202 is coupled to “Liveness” module 206 operable in accordance with one or more embodiments of the present invention to verify that the speech used to identify an end-user is from a live person. The IVR module 202 and liveness module 206 may reside on the same data processing apparatus such as a computing platform configured as a server. Optionally, they may reside on separate apparatus such as within the same data processing apparatus rack or even across local or wide area networks. The customer data storage 204 may be a bulk storage platform again within the same data processing apparatus rack as the platform supporting the IVR and Liveness modules, or disposed remotely therefrom.

Optionally, devices 106 and 108 may execute applications installed thereon that directly transfer audio from the audio input devices over the data channel to the “liveness module” 206 and “customer data storage” 204 without passing through the IVR. Such an arrangement would incorporate an application program interface to mediate access from devices 106 and 108 to the back-end services.

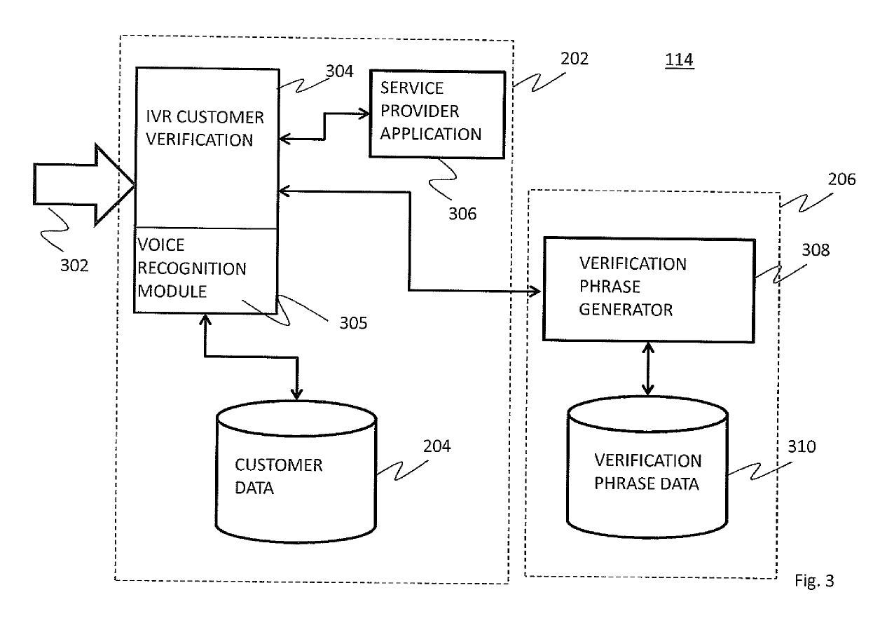

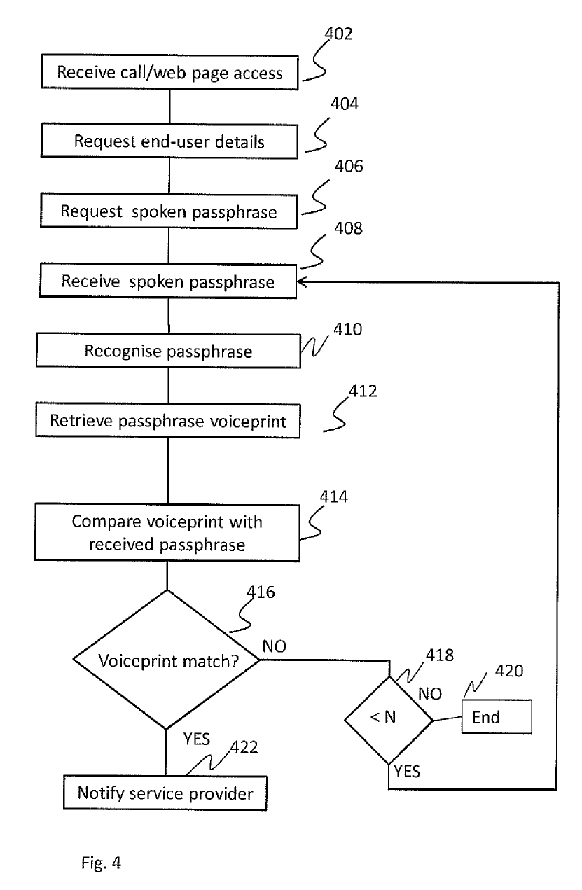

Operation of the IVR system 114 and its respective modules and sub modules will now be described with reference to FIG. 3 and the process flow control chart illustrated in FIG. 4.

IVR module 202 resides on a computing platform comprising typical processing resources including, without limitation, a processor module including an instruction buffer, input and output modules including communications network interfaces where appropriate, a local memory such as a random access memory, and a data and instruction bus coupling the various processing resources together for the transfer of data and instructions. The IVR module 202 includes an IVR customer verification module 304 to which is input one or more voice channels 302. In the described embodiment, the IVR customer verification module 304 also includes a voice recognition module 305 for recognising speech input to the verification module. The IVR customer 304 is coupled to the customer data storage 204. A service provider application 306 may also reside on the IVR module 202 to provide an interface to the IVR customer verification module for the service provider customer service representatives (CSRs). The service provider application 306 may generate a customised screen display for a CSR so that an interaction with an end-user may be monitored and the end user's data displayed to the CSR for use during a transaction with the end user.

IVR customer verification module 304 resides in a ready state waiting for a telephone call or webpage access opening one of the voice channels 302. Referring now to FIG. 4, in response to the IVR customer verification module 304 receiving a telephone call or voice access (step 402) a request for end user details (step 404) is issued. The request may be issued over the voice channel if it is a two-way channel. Optionally, or additionally, the request may be made through the webpage if web access to the IVR 114 has been initiated. In the described embodiment the end user is asked to provide the details via verbal input, either via a telephone or computer microphone depending upon the mode of access to the IVR system. In optional embodiments, the user details may be input via a telephone handset using DTMF tones or through a webpage using a keyboard or keypad.

In the described embodiment Account Number Verification (ANV) is utilised and the end-user is asked to say their account number (step 404). A voice recognition module 305 running in the IVR customer verification module 304 recognises the account number and the IVR customer verification module 304 retrieves a passphrase corresponding to the account number from customer data storage 204 and sends a request to the end user to say the passphrase (step 406). If the account number is not recognised step 404 may be repeated a predetermined number of times before denying access to the IVR system 114.

The spoken passphrase is received by the customer verification module 304 over the voice channel 302 (step 408) and the voice recognition module 305 confirms that the passphrase received from the end user is what was expected (step 410). At step 412 the customer verification module 304 retrieves from customer data storage 204 a passphrase voiceprint corresponding to the end user details requested and received in step 404 above.

The retrieved voiceprint is compared with the received passphrase at step 414 to determine if the voiceprint matches the received passphrase (step 416). If there is no match the process flow control proceeds to step 418 where it is determined if the number of mismatches is less than a threshold value “N”. If the number of mismatches is less than the threshold value the procedure returns to step 406 and requests a spoken passphrase. Otherwise, the procedure flows to step 420 where it ends and access is denied to the IVR system 114.

If the received passphrase matches the voiceprint the process flows to step 422 where the service provider is notified, for example by notification message to the service provider application 306.

Although speech recognition and voice verification in IVR systems and other system requiring user authentication and verification is a relatively well established technology for providing security for such systems, it is a technology that is nevertheless vulnerable to fraudsters. For example, fraudsters may record an end-user engaging with the IVR system and speaking their passphrases, such as their PIN numbers, account numbers and the like. The fraudster may then later play the recorded passphrase to the IVR system in an attempt to authenticate themselves to the IVR system as a registered end user having the recorded passphrase assigned to them. In this way, fraudulent activity such as obtaining funds by deception, and obtaining access to personal and confidential data may be perpetrated.

Liveness module 206 is included in embodiments of the IVR system 114 in accordance with the present invention and operates to generate passphrases which inhibit or at least reduce the likelihood of fraudulent activity based on recordings of end-users speaking passphrases.

In general overview, liveness module 206 is configured to generate a challenge, hereinafter referred to as a verification phrase, comprising verification words distributed in an unpredictable and preferably random pattern in the verification phrase. The verification words are acquired when an end user registers with the IVR system. Subsequently, when an end-user wishes to transact with the IVR system they are prompted to utter a verification phrase including verification words acquired during registration. The verification words identified in the spoken verification phrase and compared with voiceprint is recorded during registration process for those verification words.

Liveness module 206 is configured to generate verification phrases in which the verification words are distributed unpredictably. That is to say, it would be very difficult for a fraudster to predict what order the verification words are to be placed, and furthermore what the actual verification phrase as a whole will be. Preferably, the distribution of verification words amongst the various passible locations in a verification phrase is random although in practice a pseudo-random algorithm is likely to be employed.

Ideally, the verification words form a so-called “strong word set”. A strong word set is a set of words, sometimes called a vocabulary, from which a number of words may be selected that can be fixed into a small number of meaningful phrases. Having only a small number of meaningful phrases capable of being formed from the word set is desirable in automated processes since it reduces the processing necessary to construct the verification phrase. Furthermore, the generation of verification phrases for the registration phase can be simplified, since only a small number of phrases containing the verification words can be generated.

In the embodiment illustrated in FIG. 3, liveness module 206 includes a verification phrase generator 308 and verification phrase data including a verification word set 310 stored on a suitable storage medium. The verification phrase generator 308 communicates with IVR customer verification module 304 via which a verification phrase generated in the liveness module 206 may be presented to an end-user, for example over voice channel 302, and a verification phase response spoken by the end user may be communicated from the IVR customer verification module and then forwarded to the verification phrase generator 308.

In one embodiment in accordance with the present invention, liveness module 206 is configured to generate a challenge-response based upon date expressions; that is to say, expressions comprising the number of a day, a month and a year. For example, 25 Dec. 1922.

In order to produce a very strong word set for generating verification phrases, not all possible days are used. In this example, just the digits 1 to 9, all of the months and just the years beginning with “19” and “20” are used. While this provides for 21,600 (9×12×200) possible dates, if the day and month order can be swapped and it is possible merely to refer to a month by number not just by name the number of possible date combinations increases by 4 to 86,400. If the possible pattern of dates includes starting with the year then the number of possible combinations further increases another four-fold to 345,600. Thus, there are a very large number of possible combinations for a verification phase. However, the patterns in terms of where verification words may be placed are relatively restricted which reduces the processing required. This fulfils a definition for a strong word set.

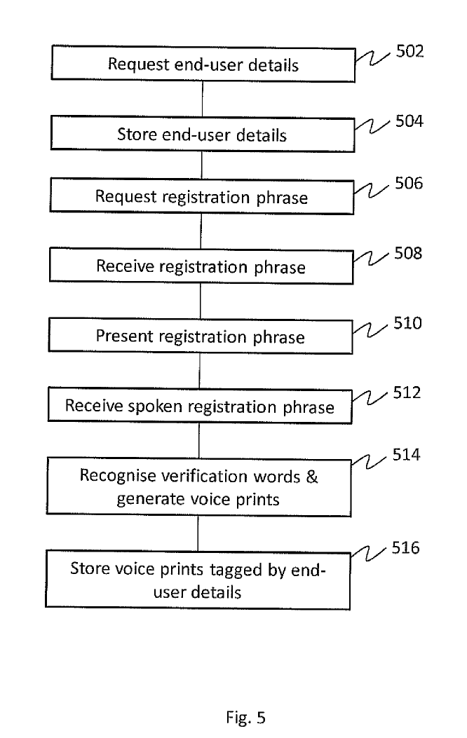

Initially, a prospective end user must first register with the IVR system 114. The registration process is undertaken by the IVR module 202. Responsive to a prospective end-user requesting registration, the IVR module 202 invokes a registration routine which configures the IVR module 202 to operate in accordance with the process control flow diagram illustrated in FIG. 5.

Initially, the registering end user's details are requested, step 502, such as contact address, telephone number and other identifier data. The end user's details are stored, step 504 and the IVR module 202 requests a registration phrase from the liveness model 206, step 506. The IVR module 202 receives the registration phrase from the liveness module together with a list of the verification words utilised in the registration phrase, step 508, and presents the registration phrase to the registering end user, step 510. Presentation of the registration phrase may be by an audio message over speech channel 302, or additionally or optionally in graphic format (including plain text format) via a web page depending upon the mode of interaction the end user is utilising.

IVR module 202 then receives a spoken registration phrase from the registering end user, step 512. The speech recognition module in the IVR module 202 is then invoked to recognise the verification words utilised in the registration phrase and generate voice prints for them, step 514. The voice prints are then stored in association with the registering end user's details so that they may be retrieved when the end user subsequently wishes to access the IVR system 114.

The structure and operation of the liveness module 206 will now be described.

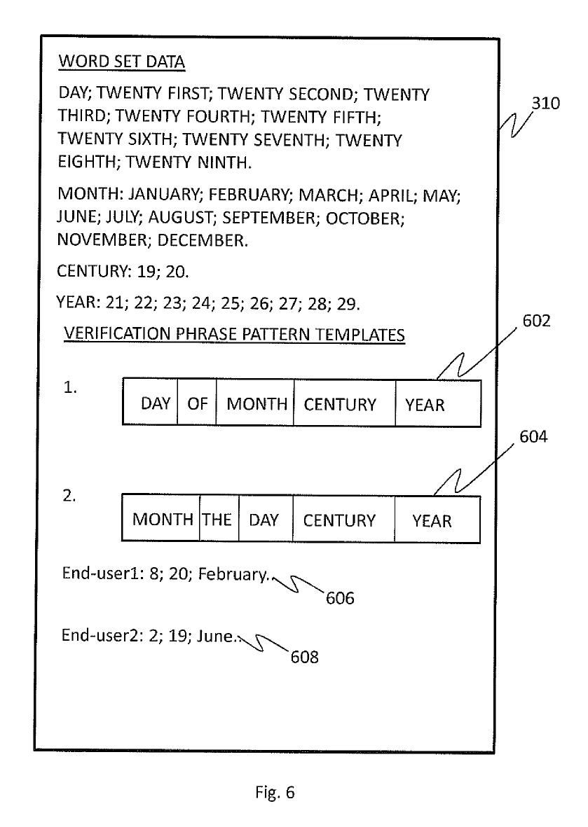

FIG. 6 illustrates the structure of the verification phrase data 310. In the illustrated embodiment, date expressions are utilised. In particular, the digits 1-9, the century numbers “19” and “20” and decade years 21-29 are utilised. The verification words are any of the digits 1-9 together with the numbers 19 and 20. Additionally, two verification phrase pattern templates, 602 and 604, are provided, the difference being that the day and month slots in the templates are juxtaposed. Also, the filler word “of” is placed between the day and month of the first verification phrase pattern template 602 and the word “the” is placed between the month and day of the second verification phrase pattern template 604. Whilst it will be evident to the person of ordinary skill in the art that respective verification phrase pattern templates 602 and 604 need not necessarily be stored as such in a storage device for the liveness module 206, nevertheless the liveness module 206 will be configured such that in operation thereof one or other of the templates will be invoked for generating a verification phrase. In accordance with the general principle of operation of the liveness module 206 the choice of verification phrase template to be invoked will be made in an unpredictable and preferably random (pseudo-random) manner.

The verification words are split into respective types: single digit; month; century; and year. The type designation for a verification word is used by the liveness module verification phrase generator 308 to determine where a verification word is to be placed in a verification phrase template when generating a verification phrase.

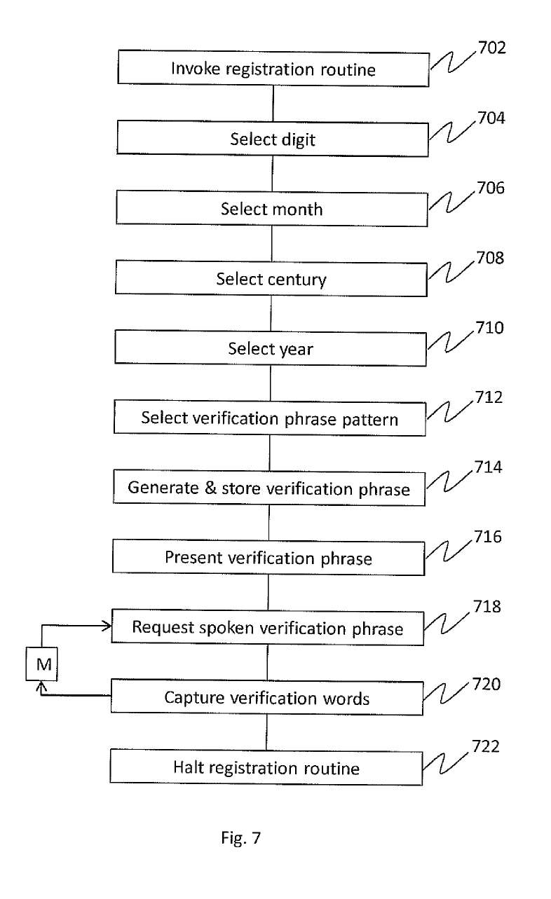

Operation of the liveness model 206 for a particular end user starts with the end user registration process. The verification phrase generator 308 is configured, for example by computer program elements such as instructions and data, to operate in accordance with the process flow control chart illustrated in FIG. 7.

For registration, in order to sample the maximum number of instances of the above available verification words, the verification phrase generator 308 is configured to respond to a request from the IVR customer verification module 304 for a registration phrase (step 506) to invoke the registration routine for the verification phrase generator 308 and to generate a registration phrase (step 702) with:
a date (day part) in the range 21-29 (to ensure the verification phrase always includes a “20);
a random month; and
a year in the ranges 1921-29 or 2021-29. This ensures that the verification phrase always includes a digit in the range 1-9, and a second “20”, and either a third “20”, or a “19”.

Optionally, the verification phrase generator 308 may be configured to use only years in the range 1921-29, to ensure that there is always a “19” and “20” available for verification.

In the illustrated embodiment the registration phase generates a verification phrase with: a month, a digit in the range 1-9, and either three “20”s, or two “20”s and a “19”. The verification phrase generator selects a day in the range 21-29 at step 704, a month at step 706, the century “20” or “19” at step 708 and the year at step 710, to be used in the verification phrase. At step 712, one of the verification phrase pattern templates is selected. In the described embodiment, the selection of the various types of verification word and the verification phrase pattern is made in accordance with a pseudo-random routine. At step 714 the registration verification phrase is generated by populating the relevant slot in the selected verification phrase pattern template with the day, month, century and year previously selected, and the generated registration verification phrase is then stored in memory in association with the end user identification data in order for the correct verification phrase to be retrieved when the end-user later logs onto the system.

The registration verification phrase is then presented to the end user undergoing registration, step 716, over voice channel 302. Optionally, the verification phrase may be presented graphically via a webpage if that is the mode of registration the end user is using. The registering end user is then requested to speak the registration verification phrase, step 718, and the verification words in the spoken phrase are captured by the liveness module 20, a voice print formed of them and the voice prints stored in association with the end user identification data, step 720. Examples of end user data and their association with end-user application data is illustrated in FIG. 6 and labelled reference 606 and 608.

Steps 718 and 720 are repeated “M” times in order to form voice prints of the verification words that are robust and have sufficient variation in them to avoid false negatives when the end-user is later verified. Once step 718 and 720 have been repeated “M” times the registration routine halts, step 722.

Turning now to the liveness verification mode of operation of the verification phrase generator, it is desirable to allow the broadest possible set of liveness verification phrases whilst ensuring that there is sufficient information to perform a robust verification against the verification words captured at registration. In the illustrated embodiment, this may be achieved by capturing for each verification phrase at least one of “19” or “20”, and either the month, or the digit captured at registration.

The principle behind the generation of a liveness verification phrase will now be described in general outline. There are three possible slots where the century type verification word can be fitted in either of the verification phrase patterns, e.g. “January the twenty first nineteen twenty three” or “twenty first of January nineteen twenty three”. If a “19” was captured at registration it is desirable to always use it since if a “19” is not always captured then when it is captured it should be used since the century part is the only slot where a “19” will occur.

If only “20”s were captured at registration there are three slots identified into one of which a “20” should be forced, allowing the other two to be randomised (pseudo random). When the randomisation for those slots is made it is possible that “19” and/or another “20” is captured, and those may also be used for verification. If the century slot is not used for a verification word the possible random range may be made as large as the designer of the IVR system desires, e.g. 16^{th} to 21^{st} century (i.e 16- to 20-) to give further unpredictability. If the decade slot is not used for a verification word the possible random range is “20”, “30”, “40” . . . “90”. Decades starting 0 or 1 are omitted, since they change the shape of the overall phrase and reduce the available slots for the fixed part.

For the second guaranteed verification word, the system randomly (pseudo-random) selects the month or the digit that was captured at registration, and randomises (pseudo-random) the generation of the other. Thus, if the month is randomly selected then the same month that was captured at registration must be included in the liveness verification phrase, whilst the last digit of the year may be picked at random from the range 1-9. If the digit is to be the verification word then a random month is selected, and then the year part is selected to have the digit that was captured at registration.

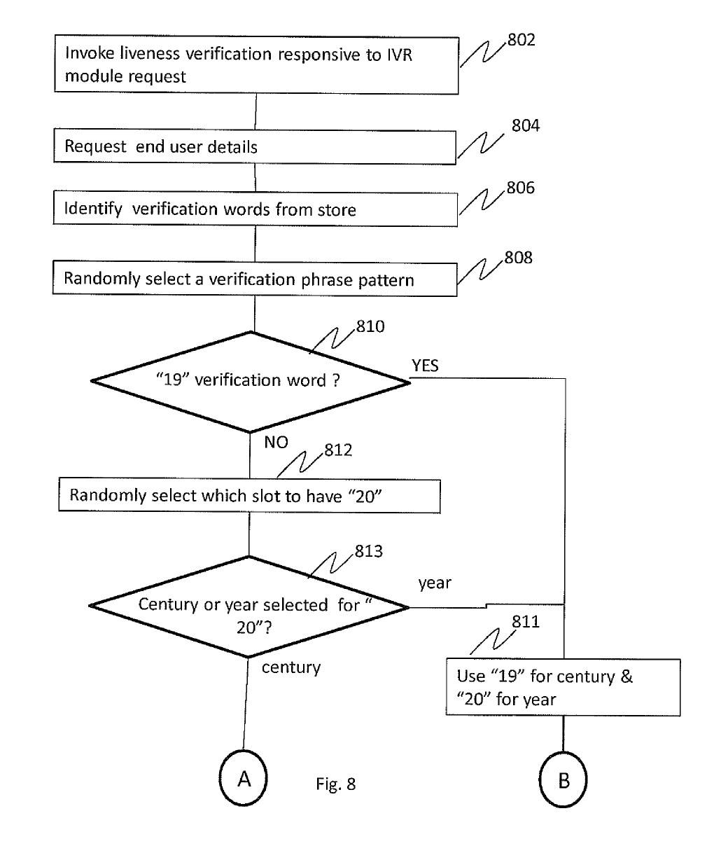

An illustrative example of the operation of the verification phrase generator 308 when in the liveness verification mode will now be described with reference to the process control flow diagram illustrated in FIG. 8.

The liveness verification mode of operation for the verification phrase generator 308 is invoked responsive to a request from IVR module 202 in connection with an end-user seeking to access the IVR system 114, step 802. The verification phrase generator 308 then request the end-user details from the IVR customer verification module 804.

Responsive to receipt of the end-user details from the IVR customer verification module the verification phrase generator 308 identifies the verification words established from the verification phrase generated for that end user during registration, step 806. Typically, the verification words are identified by looking them up in the liveness verification module memory against the phrase data end-user details with which they are associated. In this example, “end-user1” is seeking to access the IVR system 114 and so the verification words 606 assigned to end-user1 are identified in storage media 310.

Next, generation of a liveness verification phrase for presentation to the end-user is initiated. A verification phrase pattern is randomly selected (typically pseudo-randomly) at step 808. The verification phrase generator 308 then checks for “19” being a verification word at step 810 in the end-user's registration phrase. If “19” is a verification word then “19” is assigned to a century slot in the selected phrase pattern and “20” in the year slot, step 811. Process flow control then proceeds to decision step 816.

If “19” is not a verification word then verification phrase generator 308 defaults to select “20” and randomly (pseudo-random) selects which of century and year slots to populate with a “20”, step 812. Process control then flows to step 813 where it is determined which of the year slot and century slot is selected for the digit “20”. If the year slot is selected for “20” then the verification phrase generator places “19” in the century slot and “20” in the year slot, step 811. Otherwise, if the century slot is selected for “20” then the year slot is defaulted to be populated with “20”, step 814.

The process for the verification phrase generator then flows to step 816 in which the month or digit is randomly (pseudo-random) selected to be a verification word. If month is selected then the month identified as a verification month for the end user is inserted into the month slot of the selected verification phrase pattern, step 818. Thereafter, a randomly selected (pseudo-random) digit is selected for the digit slot step 822.

Alternatively, if the digit is selected at step 816 then at step 820 the digit identified as the verification word for the end user is inserted into the digit slot of the selected verification phrase pattern. At step 824 a randomly (pseudo-random) selected month is inserted into the month slot.

Process flow control for the verification phrase generator flows to step 826 from either of step 822 or 824 depending on which route was taken, at which step the generated verification phrase is forwarded to the IVR module 308 for presentation to the end user. The process then halts at step 828.

Although an embodiment in accordance with the present invention has been described above in which date expressions have been used for verification phrases, embodiments of the invention are not limited to using date expressions. Any form of expression may be used, it being desirable that the expression has a natural language meaning in order to make it sufficiently memorable that a user can repeat it accurately when registering with an IVR system or initiating a transaction and verifying themselves to the IVR system.

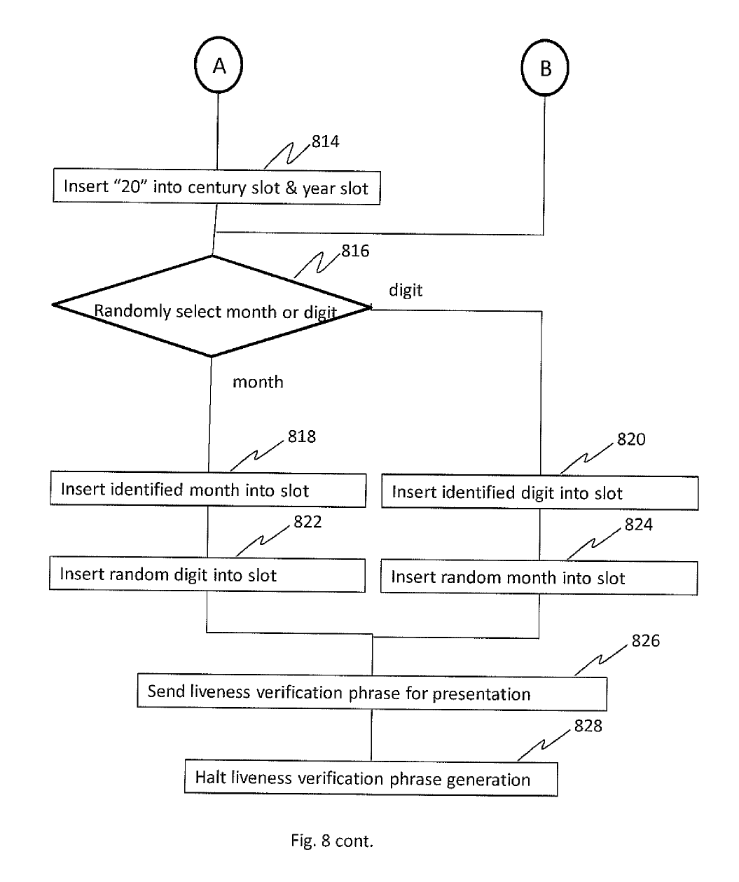

It is of course helpful if the word set from which verification phrases are to be generated comprises words that are semantically related to one another. Another non-limiting example is illustrated in FIG. 9 which shows a word set in which the words are related to one another since they concern football clubs within the English premier league for the season 2006/7. The information comprises the name of the football club, the name of the ground at which they play and a nominal ground capacity rounded to the nearest thousand.

In FIG. 9, words which may be suitable as verification words are italicised. The normal ground capacity comprises a decade followed by a digit and then followed by the term “thousand”.

As will be readily understood by the person of ordinary skill in the art, a verification phrase may be generated having the form “[club] play at (the) [ground] having a capacity of [capacity]”. Optionally, the phrase may be of the form “(the) [ground] has a capacity of [capacity] and is where [club] play”. The term “the” is placed in brackets since in some instances it may be necessary to place it before the name of the ground and in other instances unnecessary. For example, it is only necessary to place the term “the” before ground name ending in the term “stadium”.

When a new user registers for the system, a verification phrase may be chosen which includes either a part of the club name such as “united” and/or a part of a ground name such as “park” as verification words together with a corresponding capacity. However, in order to provide a wider variety of verification words, the capacity need not correspond to a true capacity, but be generated from a set of verification words comprising decade, the digit 1-9 and the term “thousand”. In this way, a verification phrase may be generated for registration purposes using various combinations of words, even to the extent of it accurately placing clubs and grounds together, with pseudo-randomly generated capacities.

Once the verification phrase has been repeated by the user and the voiceprint of the verification words recorded, then future verification of the user may be verified by generating from the word set illustrated in FIG. 9 a phrase comprising a club name, ground name and capacity including the verification words assigned to that user.

Naturally, the words illustrated in FIG. 9 are not intended to be meaningful by virtue of any expectation that the user will know what football club plays at what ground having what capacity, but that the various verification words are semantically linked so as to make a meaningful and understandable natural language phrase.

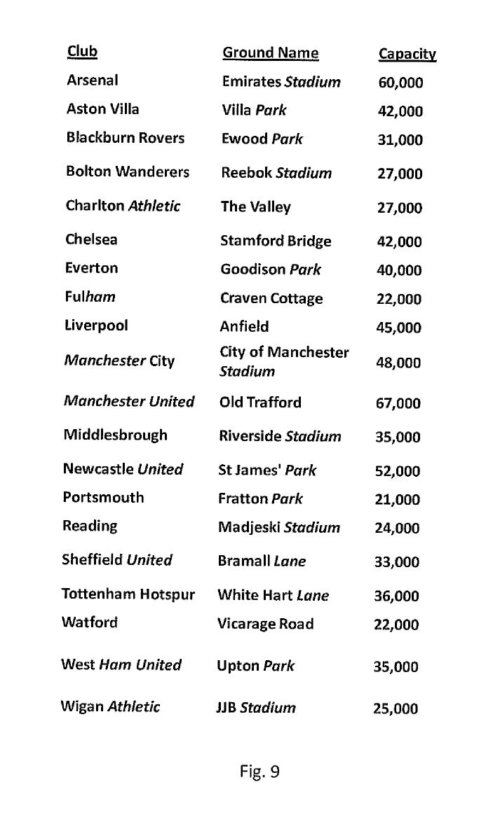

Another embodiment in accordance with the present invention is illustrated in FIG. 10. This further embodiment may be incorporated in a system such as illustrated in Fig.1 as one of the modes of operation. Optionally, the system illustrated in FIG. 10 may be implemented as a service for systems that require voice verification.

A mobile computing device such as a smartphone 1002 includes a verification application module.

The smartphone may have customer data storage area 1004 and/or utilise a remote customer data storage facility 2008 over communications network 1006. Communications network 1006 may be any suitable network for data communication and include alone, or in combination with two or more of each other, a Local Area Network, Internet, PSTN, Asynchronous Transfer Mode (ATM) for example.

Smartphone 1002 communicates with the remote customer data storage 1008 over network 1006. Additionally, smartphone 1002 may also communicate with Applicaton Program Interface (API) 1010 which provides access to Liveness module 206. Liveness module 206 may be a standalone module executing on dedicated data processing apparatus, may execute on data processing apparatus on which other modules may execute or may be incorporated with a system such as that illustrated in FIGS. 1 -3.

The architecture illustrated in FIG. 10 provides an arrangement in which the liveness module 206 may be accessed and utilised as a separate function not being part of an overall authentication and verification system. Thus, a system requiring voice authentication and verification may utilise the functions provided by liveness module 206 through access provided by the API 1010.

In the embodiment illustrated in FIG. 10 smartphone 1002 may invoke an application module for voice verification responsive to user input. The voice verification application module may be a module downloadable to the smartphone or the module is provided with the smartphone at the time of purchase or was subsequently loaded onto the smartphone using program storage media such as memory cards or the like.

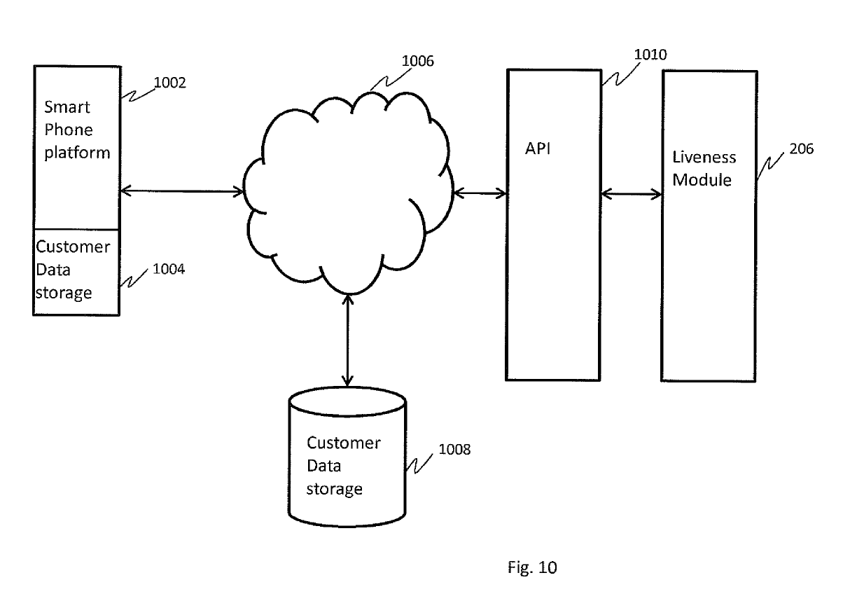

Initially, a user must first register with the liveness module 206. For registration of a new user the voice verification application module may operate in accordance with the process flow control diagram illustrated in FIG. 11. Responsive to a user initiating the voice verification application module, user information is requested, step 1102, and the information received, step 1104. The user information is stored, step 1106, in either or both of local customer data storage 1004 and remote customer data storage 1008.

The voice verification application module sends a message over network 1006 to contact API 1010 indicating that a new user wishes to register with the liveness module 206, step 1108.

The voice verification application module receives a registration phase from the API 1010 across network 1006, step 1112. The voice verification application module presents the registration phrase for the new user to the smartphone, step 1114, such presentation being by audio or visual presentation using the speaker or display of the smartphone respectively. The new user speaks the registration phrase which is recorded by the voice verification module application, step 1116, and the recorded phrase is uploaded to the API 1010, step 1118.

The process of presenting the registration phrase to the user, recording it and uploading it to the API is repeated “M” times, step 1122, in much the same way as is the case with the process illustrated in FIG. 7. Once the registration phrase has been recorded and uploaded “M” times the process flows to step 1120 where the procedure is halted.

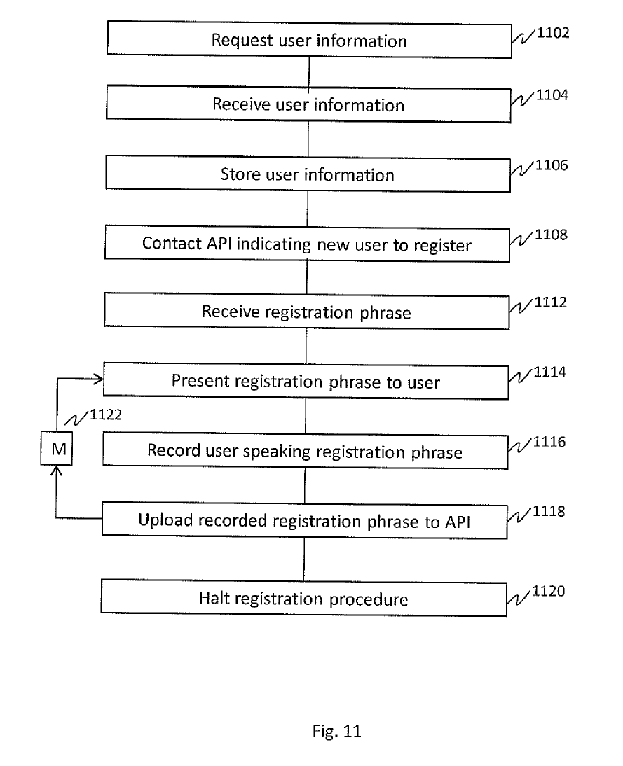

FIG. 12 illustrates a process flow control diagram for the API 1010 during registration of a new user. The API 1010 is in a ready mode and receives notice of a new user at step 1202 following the voice verification application module sending a message to the API 1010. Responsive to receiving notice of a new user, a registration phrase is requested from liveness module 206, step 1204. Generation of a registration phrase by liveness model 206 is in accordance with the process illustrated in FIG. 7.

Following receipt of the registration phrase from the liveness module 206, API 1010 returns, step 1206, the registration phrase to the voice verification application module running on the smartphone terminal 1002. The API 1010 then waits for the next contact, step 1208.

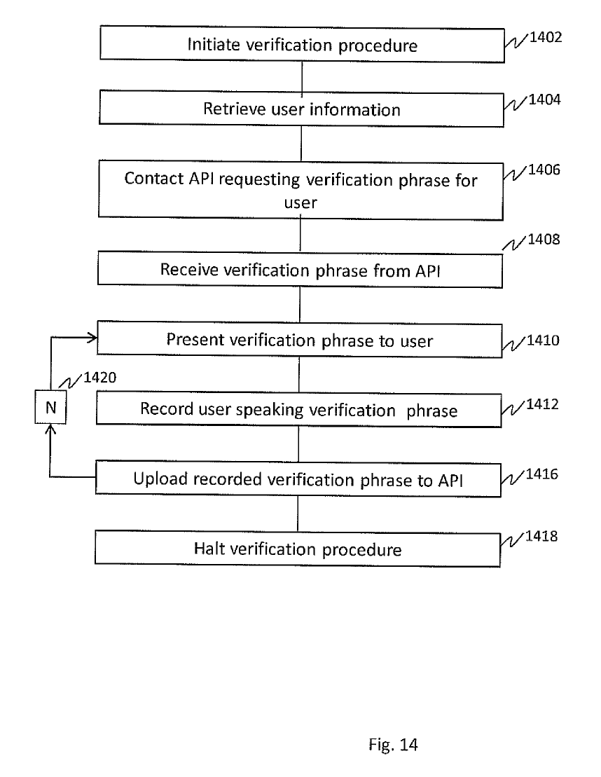

Turning now to FIG. 14, there is illustrated a process flow control diagram for the operation of the voice verification application module running on smartphone 1002 during verification of an existing user. Responsive to user input, the voice verification application module on the smartphone 1002 is initiated, step 1402.

Responsive to initiation of the voice verification procedure, the user's information is retrieved from customer data storage, step 1404. In the described embodiment it is assumed that only one user of the smartphone 1002 is registered through the voice verification application module running on the smartphone. The user of the smartphone may have to authenticate themselves to the smartphone or may merely rely on possession of the smartphone providing sufficient security. However, it is possible that the voice verification application module may be configured such that more than one user may register using the same smartphone.

The voice verification application module initiates contact with the API and requests the verification phrase for the user, step 1406, and receives a verification phrase from the API, step 1408. At step 1410, the verification application module presents the verification phrase to a user using either or both audio or visual display mechanisms provided on the smartphone 1002. The user speaking of verification phrase is recorded, step 1412, and the recorded phrase is uploaded to API 1010, step 1416. The process of presenting a verification phrase to the user, recording the user speaking the verification phrase and uploading a recording of the verification phrase to the API is repeated “N” times, step 1420. The verification procedure is then halted, step 1418.

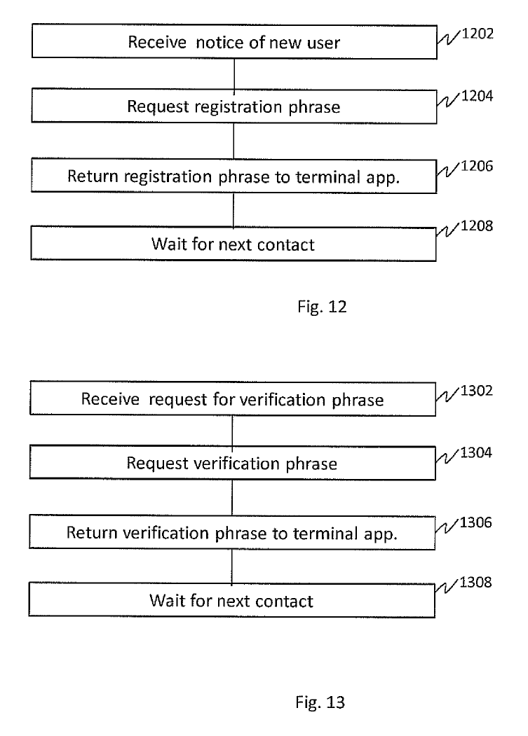

Operation of API 1010 during user verification will now be described with reference to the process flow control diagram illustrated in FIG. 13. At step 1302, the API receives a request for a verification phrase from the voice verification application module running on smartphone 1002. Responsive to that request, API 1010 requests a verification phrase from liveness module 206, step 1304. Operation of liveness model 206 in generating a verification phrase is in accordance with the flow diagram illustrated in FIG. 8.

API 1010 receives a verification phrase and returns the verification phrase to the voice verification application module running on smartphone 1002, step 1306. API 1010 then waits for the next contact, step 1308.

Insofar as embodiments of the invention described above are implementable, at least in part, using a software-controlled programmable processing device such as a general purpose processor or special-purposes processor, digital signal processor, microprocessor, or other processing device, data processing apparatus or computer system or platform it will be appreciated that a computer program for configuring a programmable device, apparatus or system to implement the foregoing described methods, apparatus and system is envisaged as an aspect of the present invention. The computer program may be embodied as any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Peri, Matlab, Pascal, Visual BASIC, JAVA, ActiveX, assembly language, machine code, and so forth. A skilled person would readily understand that term “computer” in its most general sense encompasses programmable devices such as referred to above, and data processing apparatus and computer systems.

Suitably, the computer program is stored on a carrier medium in machine readable form, for example the carrier medium may comprise memory, removable or non-removable media, erasable or non-erasable media, writeable or re-writeable media, digital or analog media, hard disk, floppy disk, Compact Disk Read Only Memory (CD-ROM), Company Disk Recordable (CD-R), Compact Disk Rewriteable (CD-RW), optical disk, magnetic media, magneto-optical media, removable memory cards or disks, various types of Digital Versatile Disk (DVD) subscriber identity module (SIM), tape, cassette solid-state memory. The computer program may be supplied from a remote source embodied in the communications medium such as an electronic signal, radio frequency carrier wave or optical carrier waves. Such carrier media are also envisaged as aspects of the present invention.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

In view of the foregoing description it will be evident to a person skilled in the art that various modifications may be made within the scope of the invention. For example, The IVR system 114 may reside on a single computing platform such as a single server, or maybe distributed over plural computing platforms for example local area networks or over a wide area network such as the Internet. Any suitable data processing apparatus may be used as the computing platform or platforms and embodiments in accordance with the present invention are not limited to any particular types or configuration of data processing apparatus.

Additionally, a greater range of days and decades may be used thereby increasing the variance in the verification phrase for both registration and liveness verification which leads to an increased protection from fraud.

Moreover, embodiments and uses of a liveness verification system such as described herein are not limited to interactive voice response systems but may be utilised in any environment for which voice authentication is utilised. Although a smartphone terminal is illustrated in FIG. 10, embodiments in accordance with the aspect of the present invention described with reference to FIGS. 10-14 are not limited to smartphone platforms, but may include any computing platform including mobile or portable platforms or indeed desktop platforms.

Although embodiments in accordance with the present invention have been described utilising speech recognition, embodiments are also envisaged which do not require speech recognition. For example, an arbitrary block of speech may be recorded as a voiceprint and compared with a recorded voiceprint. Such an approach may rely upon there being sufficient correlation between the arbitrarily selected block of speech and the voiceprint against which it is compared. Optionally, the whole speech phrase uttered by a user during verification may be recorded as a voiceprint and compared with the registration voiceprint. Whilst not utilising speech recognition reduces the amount of processing necessary in the system, it may also require a greater amount of voiceprint data to be recorded and compared.

The scope of the present disclosure includes any novel feature or combination of features disclosed therein either explicitly or implicitly or any generalisation thereof irrespective of whether or not it relates to the claimed invention or mitigate against any or all of the problems addressed by the present invention. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

1. A voice verification module, configured to:
select from a store of verification words one or more verification words responsive to a request for a verification phrase;
form a verification phrase including said one or more verification words distributed throughout said verification phrase.

2. A module according to claim 1, further configured to form said verification phrase with one or more non-verification words included in said verification phrase.

3. A module according to claim 1, further configured to form said verification phrase so as to have a natural language meaning.

4. A module according to claim 2, further configured to form said verification phrase with said one or more non-verification words positioned to form a verification phrase having a natural language meaning.

5. A module according to claim 3, further configured to select said non-verification words from the group including: prepositions; conjunctions; definite article; indefinite article, and parts of speech.

6. A module according to claim 1, wherein said verification word store comprises a strong word set.

7. A module according to claim 1, wherein said store of verification words is arranged into two or more groups of verification words, each group comprising one or more verification words corresponding to a category of verification word.

8. A module according to claim 7, further configured to:
select a verification word from said two or more groups;
form said verification phrase by placing a selected verification word into a position in said verification phrase designated for as group associated with said selected verification word.

9. A module according to claim 8, further configured to provide a verification phrase template comprising two or more positions designated for said two or more groups for populating with said selected verification words from respective two or more groups forming said verification phrase.

10. A module according to claim 9, further configured to select a verification phrase template from a store of a plurality of a verification phrase templates, respective verification phrase templates having different distributions of positions for said groups.

11. A module according to claim 1, wherein said one or more verification words are distributed in an irregular and/or unpredictable manner throughout said verification phrase.

12. A user authentication system, comprising:
a voice verification module configured to:
select from a store of verification words one or more verification words responsive to a request for a verification phrase;
form a verification phrase including said one or more verification words distributed throughout said verification phrase,
said system configured to:
request a registration verification phrase from said voice verification module
responsive to said system receiving a request to register a new user;
receive said registration verification phrase from said voice verification module; and
present said registration verification phrase to said new user.

13. A system according to claim 12, wherein said voice verification module is further configured to pseudo-randomly select said one or more verification words from said store of verification words.

14. A system according to claim 12, further configured to:
receive a voice utterance of said registration verification phrase from said user;
recognise said one or more verification words in said utterance; and
record a registration voiceprint of said one of more verification words recognised in said utterance and store each said voiceprint in association with a user identity for said new user and each said verification word.

15. A system according to claim 12, said system configured to:
request a verification phrase from said voice verification module responsive to a registered user initiating a transaction with said IVR system;
present said verification phrase to said registered user;
receive a voice utterance of said verification phrase from said registered user;
recognise one or more verification words associated with a user identity corresponding to said registered user in said utterance and record a voiceprint for each recognised verification word; and
compare said voiceprint with said registered voiceprint; and
wherein said voice verification module is further configured to respond to said request to select from said store of verification words one or more verification words associated with said user identity; and
provide said verification phrase to said system for presentation to said registered user.

16. A method of operating data processing apparatus for voice verification, said method comprising:
selecting from a store of verification words one or more verification words responsive to a request for a verification phrase; and
forming a verification phrase including said one or more verification words distributed throughout said verification phrase.

17. A method according to claim 16, further comprising forming said verification phrase with one or more non-verification words included in said verification phrase.

18. A method according to claim 16, further comprising forming said verification phrase so as to have a natural language meaning.

19. A method according to claim 17, further comprising forming said verification phrase with said one or more non-verification words positioned to form a verification phrase having a natural language meaning.

20. A method according to claim 18, further comprising selecting said nonverification words from the group including: prepositions; conjunctions; definite article; indefinite article, and parts of speech.

21. A method according to claim 16, wherein said verification word store comprises a strong word set.

22. A method according to claim 16, further comprising arranging said store of verification words into two or more groups of verification words, each group comprising one or more verification words corresponding to a category of verification word.

23. A method according to claim 22, further comprising:
selecting a verification word from said two or more groups; and
forming said verification phrase by placing a selected verification word into a position in said verification phrase designated for a group associated with said selected verification work.

24. A method according to claim 23, further comprising providing a verification phrase template comprising two or more positions designated for said two or more groups for populating with said selected verification words from respective two or more groups forming said verification phrase.

25. A method according to claim 24, further comprising selecting a verification phrase template from a store of a plurality of a verification phrase templates, respective verification phrase templates having different distributions of positions for said groups.

26. A method according to claim 16, further comprising distributing said one or more verification words in an irregular and/or unpredictable manner throughout said verification phrase.

27. A method according to claim 16, further comprising:
requesting a registration verification phrase responsive to receiving a request to register a new user;
receiving said registration verification phrase; and
presenting said registration verification phrase to said new user.

28. A method according to claim 27, further comprising pseudo-randomly selecting said one or more verification words from said store of verification words.

29. A method according to claim 27, further comprising:
receiving a voice utterance of said registration verification phrase from said user;
recognising said one or more verification words in said utterance; and
recording a registration voiceprint of said one of more verification words recognized in said utterance and storing each said voiceprint in association with a user identity for said new user and each said verification word.

30. A method according to claim 27 further comprising:
requesting a verification phrase responsive to a registered user initiating a transaction with said data processing apparatus;
presenting said verification phrase to said registered user;
receiving a voice utterance of said verification phrase from said registered user;
recognising one or more verification words associated with a user identity corresponding to said registered user in said utterance and recording a voiceprint for each recognised verification word;
comparing said voiceprint with said registered voiceprint;
responding to said request to select from said store of verification words one or more verification words associated with said user identity; and
providing said verification phrase for presentation to said registered user.

31. A computer program for operating data processing apparatus for voice verification and comprising one or more computer readable instructions embedded on a tangible, non-transitory computer readable medium and configured to cause one or more computer processors to perform the steps of:
selecting from a store of verification words one or more verification words responsive to a request for a verification phrase; and
forming a verification phrase including said one or more verification words distributed throughout said verification phrase.
